(19) United States
(12) Patent Application Publication
(10) Pub. No.: US 2024/0241863 A1
(43) Pub. Date: Jul. 18, 2024

(54) INFORMATION PROCESSING DEVICE, INFORMATION PROCESSING SYSTEM, INFORMATION PROCESSING METHOD AND PROGRAM

(71) Applicant: NEC Corporation, Minato-ku, Tokyo (JP)

(72) Inventor: Tomoshige FUNASAKI, Tokyo (JP)

(73) Assignee: NEC Corporation, Minato-ku, Tokyo (JP)

(21) Appl. No.: 18/561,937

(22) PCT Filed: May 27, 2021
(86) PCT No.: PCT/JP2021/020171

§ 371 Date: Nov. 17, 2023

(51) Int. Cl. G06F 16/178

(52) U.S. Cl. CPC G06F 16/1794

(57) ABSTRACT

In order to make it possible to obtain data conforming to a predetermined format without rewriting accumulated data, an information processing apparatus includes: an obtaining section that obtains target data; and a conversion section that (a) selects at least either of a first conversion process of converting a first data format into a predetermined second data format and a second conversion process of converting the predetermined second data format into a third data format associated with a matching rule defining a matching process and (b) applies the selected process to the target data.

### TECHNICAL FIELD

The present invention relates to an information processing apparatus, an information processing system, an information processing method, and a program.

### BACKGROUND ART

As a conventional format conversion method used in a data distribution platform, there have been inventions disclosed in Patent Literatures 1 and 2 indicated below.

Patent Literature 1 relates to a data format conversion processing method. According to the format conversion processing method, conversion information files describing format conversion rules peculiar to plural providers are respectively stored for provider identification codes. Then, when data having a provider identification code added thereto is input, a format conversion rule matching this provider identification code is retrieved from among the conversion information files. Thereafter, the input data is edited according to the retrieved format conversion rule.

Patent Literature 2 relates to a system for providing customer-specific data format converted data. According to the system for providing customer-specific data format converted data, when a data-receiver-side apparatus issues a data distribution request in a data format of a service-infrastructure-side apparatus, the data format of the received data of each data provider apparatus is converted, in consideration of data format information recorded in a data format recording section, into a data format of the service-infrastructure-side apparatus and is then distributed.

### CITATION LIST

### Patent Literature

### [Patent Literature 1]

Japanese Patent Application Publication, Tokukaihei, No. H08-194636 (1996)

### [Patent Literature 2]

Japanese Patent Application Publication, Tokukai, No. 2014-115860

### SUMMARY OF INVENTION

### Technical Problem

For example, in a case where supermarkets, companies A and B, are in a business partnership with each other and share Point Of Sale (POS) data so that companies A and B can utilize the POS data for business, the data possessed by company A and the data possessed by company B may sometimes have respective different formats. In such a case, the format of the data possessed by company A and the format of the data possessed by company B need to be converted into an industry standard format (hereinafter, simply referred to as a “standard format”). In a case where company A or company B uses the POS data, it takes a lot of time to convert formats of all the accumulated pieces of data of companies A and B. Further, along with increase in the amount of data which is target of data coordination, the standard format changes.

Further, according to the data format conversion processing method disclosed in Patent Literature 1 discussed above, when data having a provider identification code added thereto is input, a format conversion rule matching the provider identification code is retrieved from among the conversion information files. Then, the input data is edited according to the format conversion rule thus retrieved. However, even with use of this data format conversion processing method, it takes a lot of time to unify the formats of the accumulated pieces of data of companies A and B.

Meanwhile, according to the system for providing customer-specific data format converted data disclosed in Patent Literature 2, in consideration of data format information recorded in the data format recording section, the data format of the received data of each data provider apparatus is converted into a data format of the service infrastructure apparatus and is then distributed. However, similarly to the technique of Patent Literature 1, even with use of the system for providing customer-specific data format converted data, it takes a lot of time to unify the formats of the accumulated pieces of data of companies A and B.

An example aspect of the present invention was made in consideration of the above problems, and an example object thereof is to provide a technique that makes it possible to obtain data conforming to a standard format or a common format without rewriting accumulated data.

### Solution to Problem

An information processing apparatus in accordance with an example aspect of the present invention includes: an obtaining means that obtains target data; and a conversion means that (a) selects at least either of a first conversion process of converting a first data format into a predetermined second data format and a second conversion process of converting the predetermined second data format into a third data format associated with a matching rule defining a matching process and (b) applies, to the target data, the at least either of the first conversion process and the second conversion process thus selected.

An information processing apparatus in accordance with an example aspect of the present invention includes: an obtaining means that obtains target data having a predetermined first data format; and a conversion means that executes a conversion process of converting the data format of the target data into a second data format associated with a matching rule defining a matching process.

An information processing system in accordance with an example aspect of the present invention is an information processing system including: a first information processing apparatus; a second information processing apparatus; and a third information processing apparatus, the first information processing apparatus including: a providing means that provides target data to the second information processing apparatus, the second information processing apparatus including: an obtaining means that obtains the target data; a conversion means that applies, to the target data, a first conversion process of converting a first data format into a predetermined second data format and a second conversion process of converting the predetermined second data format into a third data format associated with a matching rule defining a matching process; a matching means that applies the matching process to the target data to which the second conversion process has been applied; and a data providing means that provides at least part of the target data to the third information processing apparatus in accordance with a result of the matching process carried out by the matching means, the third information processing apparatus including: a process executing means that obtains the data provided by the second information processing apparatus and executes a process on the data thus obtained.

An information processing system in accordance with an example aspect of the present invention is an information processing system including: a first information processing apparatus; a second information processing apparatus; and a third information processing apparatus, the first information processing apparatus including: a providing means that provides target data to the second information processing apparatus, the second information processing apparatus including: an obtaining means that obtains target data having a predetermined first data format; a conversion means that executes a conversion process of converting the data format of the target data into a second data format associated with a matching rule defining a matching process; a matching means that applies the matching process to the target data to which the conversion process has been applied; and a data providing means that provides at least part of the target data to the third information processing apparatus in accordance with a result of the matching process carried out by the matching means, the third information processing apparatus including: a process executing means that obtains the data provided by the second information processing apparatus and executes a process on the data thus obtained.

An information processing method in accordance with an example aspect of the present invention is an information processing method including an information processing apparatus carrying out: obtaining target data; and selecting at least either of a first conversion process of converting a first data format into a predetermined second data format and a second conversion process of converting the predetermined second data format into a third data format associated with a matching rule defining a matching process and applying, to the target data, the at least either of the first conversion process and the second conversion process thus selected.

An information processing method in accordance with an example aspect of the present invention is an information processing method including an information processing apparatus carrying out: obtaining target data having a predetermined first data format; and converting the data format of the target data into a second data format associated with a matching rule defining a matching process.

An information processing method in accordance with an example aspect of the present invention is an information processing method including: a first information processing apparatus carrying out: providing target data to a second information processing apparatus; a second information processing apparatus carrying out: obtaining the target data; applying, to the target data, a first conversion process of converting a first data format into a predetermined second data format and a second conversion process of converting the predetermined second data format into a third data format associated with a matching rule defining a matching process; applying the matching process to the target data to which the second conversion process has been applied; and providing the target data to a third information processing apparatus in accordance with a result of the matching process; and the third information processing apparatus carrying out: obtaining the data provided by the second information processing apparatus and executing a process on the data thus obtained.

An information processing method in accordance with an example aspect of the present invention is an information processing method including: a first information processing apparatus carrying out: providing target data to a second information processing apparatus; a second information processing apparatus carrying out: obtaining target data having a predetermined first data format; and executing a conversion process of converting the data format of the target data into a second data format associated with a matching rule defining a matching process; applying the matching process to the target data to which the conversion process has been applied; and providing the target data to a third information processing apparatus in accordance with a result of the matching process; and a third information processing apparatus carrying out: obtaining the data provided by the second information processing apparatus and executing a process on the data thus obtained.

A program in accordance with an example aspect of the present invention is a program for causing a computer to function as an information processing apparatus, the program causing the computer to function as: an obtaining means that obtains target data; and a conversion means that (a) selects at least either of a first conversion process of converting a first data format into a predetermined second data format and a second conversion process of converting the predetermined second data format into a third data format associated with a matching rule defining a matching process and (b) applies, to the target data, the at least either of the first conversion process and the second conversion process thus selected.

A program in accordance with an example aspect of the present invention is a program for causing a computer to function as an information processing apparatus, the program causing the computer to function as: an obtaining means that obtains target data having a predetermined first data format; and a conversion means that converts the data format of the target data into a second data format associated with a matching rule defining a matching process.

### Advantageous Effects of Invention

According to an example aspect of the present invention, it is possible to obtain data conforming to a predetermined format without rewriting accumulated data.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of an information processing method in accordance with the first example embodiment of the present invention.

FIG. 3 is a block diagram illustrating a configuration of a second information processing apparatus in accordance with a second example embodiment of the present invention.

FIG. 4 is a sequence diagram illustrating a flow of an information processing method in accordance with the second example embodiment of the present invention.

FIG. 5 is a block diagram illustrating a configuration of a second information processing apparatus in accordance with a third example embodiment of the present invention.

FIG. 6 is a flowchart illustrating a process of adding a data catalog.

FIG. 7 is a flowchart illustrating a process of setting a matching rule.

FIG. 8 is a view illustrating an example of an image of setting information.

FIG. 9 is a flowchart illustrating a data receiving process at the time of data distribution.

FIG. 10 is a flowchart illustrating a matching process carried out when an event occurs.

FIG. 11 is a view illustrating a specific example 1 of operation of an information processing apparatus.

FIG. 12 is a view illustrating another specific example 1 of operation of an information processing apparatus.

FIG. 13 is a view illustrating a specific example 2 of operation of an information processing apparatus.

FIG. 14 is a view illustrating a specific example 3 of operation of an information processing apparatus.

FIG. 15 is a view illustrating an example of hardware of a computer.

### DESCRIPTION OF EMBODIMENTS

### First Example Embodiment

The following description will discuss a first example embodiment of the present invention in detail with reference to the drawings. The present example embodiment is a basic form of example embodiments described later.

### <Overview of Information Processing Apparatus 1>

Specifically, an information processing apparatus 1 in accordance with the present example embodiment registers, in association with target data, a first conversion process of converting a first data format into a second data format. Further, the information processing apparatus 1 registers a second conversion process of converting the second data format into a third data format associated with a matching rule. Then, the information processing apparatus 1 selectively executes the first conversion process and the second conversion process on the target data. The information processing apparatus 1 can be used as an aspect of a data distribution platform, and can also be called a “data distribution apparatus”.

### <Configuration of Information Processing Apparatus 1>

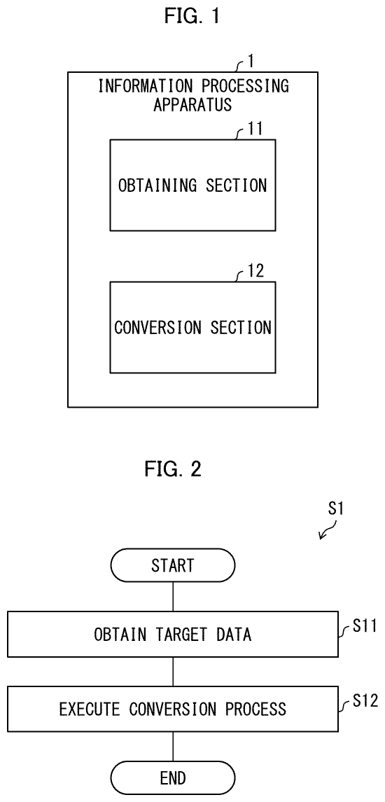

The following will describe a configuration of the information processing apparatus 1 with reference to FIG. 1. FIG. 1 is a block diagram illustrating a configuration of the information processing apparatus 1.

As shown in FIG. 1, the information processing apparatus 1 includes an obtaining section 11 and a conversion section 12. The obtaining section 11 is a configuration realizing an obtaining means in the present example embodiment. The conversion section 12 is a configuration realizing a conversion means in the present example embodiment.

The obtaining section 11 obtains target data. The conversion section 12 (a) selects at least either of the first conversion process of converting a first data format into a predetermined second data format and the second conversion process of converting the predetermined second data format into a third data format associated with a matching rule defining a matching process, and (b) applies the selected process to the target data. The matching rule is defined by, e.g., if-then rule.

Note that the obtaining section 11 may be configured to obtain target data having the predetermined first data format (corresponding to the second data format). Further, the conversion section 12 may be configured to execute a conversion process of converting the data format of the target data into the second data format (corresponding to the third data format) associated with the matching rule defining the matching process.

For example, the information processing apparatus 1 manages a data catalog, and accumulates and manages data to be provided (published). The information processing apparatus 1 is used in a data distribution platform in which event matching is carried out. In this data distribution platform, the data is distributed as Pub/Sub-type streaming data (hereinafter, which may simply be called “data” occasionally).

Note that, in the present example embodiment, the “event matching” refers to a process in which the information processing apparatus 1 receives provided (published) data and, in response to occurrence of a specific event, the information processing apparatus 1 executes a process which is in compliance with the matching rule.

A client generating and transmitting streaming data is called a “publisher”, which corresponds to a data owner (described later) or the like. Meanwhile, a client receiving the streaming data is called a “subscriber”, which corresponds to a data user (described later) or the like. The pieces of data transmitted from the publisher are registered for respective topics. The topic may also be expressed as a transmission destination of the data transmitted from the publisher. A piece of data registered in association with a certain topic can be distributed to one or more subscribers subscribing distribution of the certain topic.

The data owner provides (publishes) data associated with a specific topic name, and the data is distributed, via the data distribution platform, to a data user having has registered (subscribed) for the topic. For example, assuming that companies A and B have registered for a certain topic, data provided by the data owner in association with the certain topic can be distributed to companies A and B.

In the data catalog, for streaming data and a data store, data (which may also be called “related information”) for retrieving necessary data, such as metadata indicating descriptive information about the data, an explanation text, and/or sample data, are stored. The data store stores therein persistent data, such as streaming data.

The target data is a concept encompassing streaming data, data stored in a data store, and the like, and may include a data catalog and/or the like.

The first data format is a data format of, e.g., streaming data to be provided or data stored in the data store. The second data format is a data format different from the first data format. For example, the second data format is a standard format or a common format.

An example of the common format is described below. That is, in a case where (i) supermarkets, companies A and B, are in a business partnership with each other and share POS data so that companies A and B can utilize the POS data for business and (ii) the data possessed by company A and the data possessed by company B have respective different formats, the formats of these companies are commonized by a common format. If there exists a standard format, the first conversion process converts streaming data or the like into the standard format. Meanwhile, if there is no standard format, the first conversion process converts streaming data or the like into the common format.

The third data format is a data format associated with the matching rule defining the matching process. With the third conversion process, data of the standard format or common format is converted into a data format to which the matching rule is applicable.

### <Effects of Information Processing Apparatus 1>

As described above, the conversion section 12 selects at least either of the first conversion process and the second conversion process, and applies the selected process to the target data. Consequently, along with changing the format into a standard format or a common format, it is possible to obtain data conforming to a standard format or a common format, without rewriting accumulated data.

Further, along with changing the format into the standard format or common format, it is possible to use the matching rule as it is, without changing the matching rule having been created. Note that input data used when the matching rule is applied encompass the streaming data and the data stored in the data store.

### <Flow of Information Processing Method Performed by Information Processing Apparatus 1>

The following will describe, with reference to FIG. 2, a flow of an information processing method S1 executed by the information processing apparatus 1 configured as above. FIG. 2 is a flowchart illustrating a flow of the information processing method S1. As shown in FIG. 2, the information processing method S1 includes steps S11 and S12.

First, the information processing apparatus 1 obtains target data (S11). Then, the information processing apparatus 1 selects at least either of the first conversion process of converting a first data format into a predetermined second data format and the second conversion process of converting the predetermined second data format into a third data format associated with a matching rule defining a matching process, and applies the selected process to the target data (S12).

Alternatively, the information processing apparatus 1 may be configured to obtain target data having a predetermined first data format (corresponding to the second data format) (S1), and then to convert the data format of the target data into a second data format (corresponding to the third data format) associated with a matching rule defining a matching process (S12).

### <Effects of Information Processing Method>

As described above, this method selects at least either of the first conversion process and second conversion process, and applies the selected process to the target data. Consequently, along with changing the format into a standard format or a common format, it is possible to obtain data conforming to a standard format or a common format, without rewriting accumulated data. Further, along with changing the format into the standard format or common format, it is possible to use the matching rule as it is, without changing the matching rule having been created.

### Second Example Embodiment

The following description will discuss a second example embodiment of the present invention in detail with reference to the drawings. Note that members having identical functions to those of the first example embodiment are predetermined identical reference signs, and a description thereof will be omitted.

### <Configuration of Information Processing System 100>

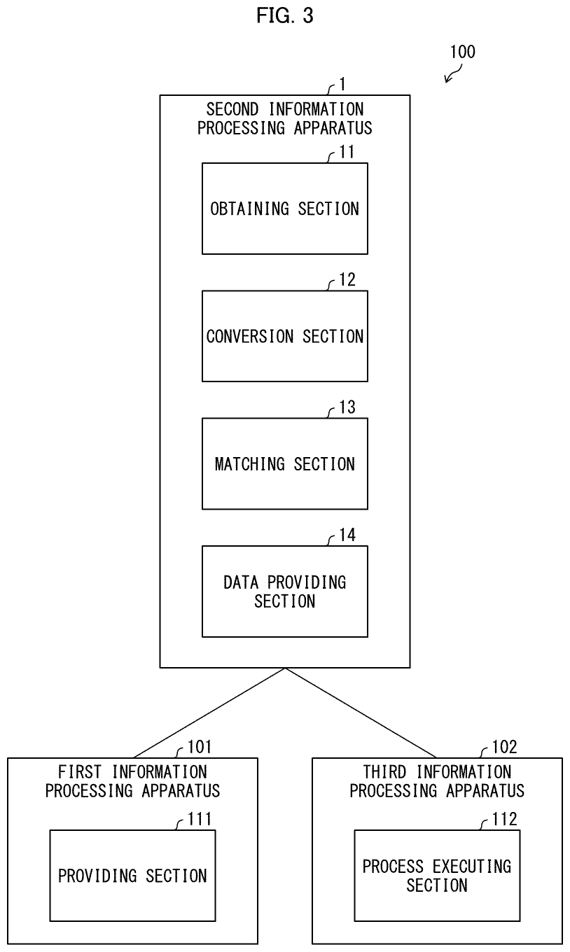

FIG. 3 is a block diagram illustrating a configuration of a second information processing apparatus in accordance with a second example embodiment of the present invention. The information processing system 100 includes a first information processing apparatus 101, a third information processing apparatus 102, and a second information processing apparatus 1. The first information processing apparatus 101 includes a providing section 111 that provides target data to the second information processing apparatus 1. In the present example embodiment, the providing section 111 is a configuration realizing a providing means. For example, the providing section 111 provides the above-described data catalog and/or the like to the second information processing apparatus 1. Here, similarly to the first example embodiment, the second information processing apparatus 1 can also be called a “data distribution apparatus”.

The first information processing apparatus 101 is a data processing apparatus used by a data owner and/or the like. The third information processing apparatus 102 is a data processing apparatus used by a data user and/or the like.

The second information processing apparatus 1 includes: an obtaining section 11 that obtains target data; a conversion section 12 that applies, to the target data, a first conversion process of converting a first data format into a predetermined second data format and a second conversion process of converting the predetermined second data format into a third data format associated with a matching rule defining a matching process; a matching section 13 that applies the matching process to the target data to which the second conversion process has been applied; and a data providing section 14 that provides at least part of the target data to the third information processing apparatus 102 in accordance with a result of the matching process carried out by the matching section 13. The matching section 13 is a configuration realizing a matching means in the present example embodiment. The data providing section 14 is a configuration realizing a data providing means in the present example embodiment.

The third information processing apparatus 102 includes a process executing section 112 that obtains the data provided by the second information processing apparatus 1 and executes a process on the data thus obtained. The process executing section 112 is a configuration realizing a process executing means in the present example embodiment.

Further, the conversion section 12 may execute at least the second conversion process, and the second information processing apparatus 1 may include a matching section 13 that applies the matching process to the target data to which the second conversion process has been applied.

Moreover, the conversion section 12 may be configured to execute the second conversion process so as to (a) select any one of a plurality of matching processes and (b) convert a predetermined second data format into a third data format associated with a matching rule defining the selected one of the plurality of matching processes, and the matching section 13 may be configured to apply, to the target data to which the second conversion process has been applied, the one of the plurality of matching processes selected by the conversion section 12.

### <Effects of Information Processing System 100>

As described above, the matching section 13 applies the matching process to the target data to which the second conversion process has been applied. Consequently, along with changing the format into a standard format or a common format, it is possible to carry out the matching process, without changing the matching rule having been created.

### <Flow of Information Processing Method Performed by Information Processing System 100>

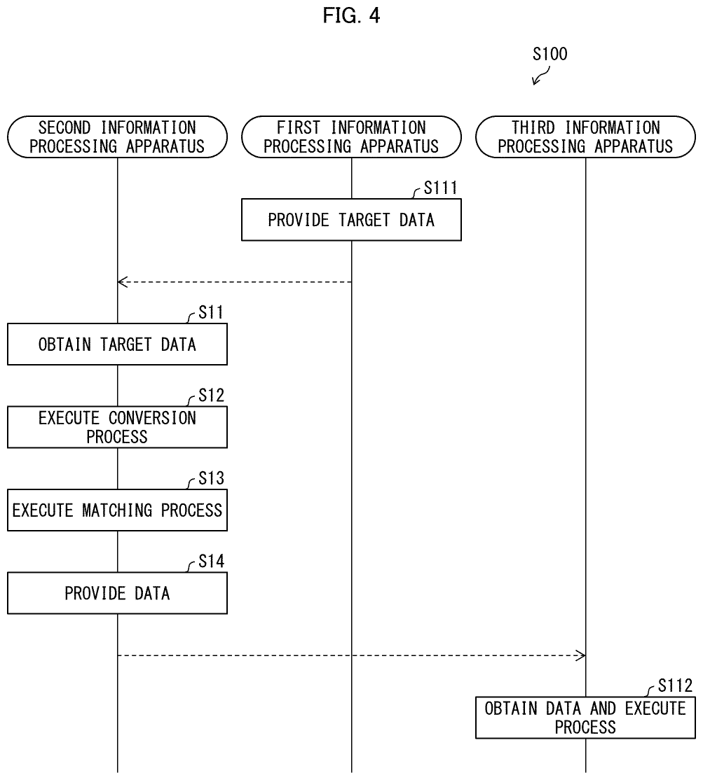

The following will describe, with reference to FIG. 4, a flow of an information processing method S100 executed by the information processing system 100 configured as above. FIG. 4 is a flowchart illustrating a flow of the information processing method S100. As shown in FIG. 4, the information processing method S1 includes steps S11 to S14, S111, and S112.

First, the first information processing apparatus 101 provides target data to the second information processing apparatus 1 (S111). Subsequently, the second information processing apparatus 1 obtains the target data (S11). Then, the second information processing apparatus 1 applies, to the target data, the first conversion process of converting a first data format into a predetermined second data format and the second conversion process of converting the predetermined second data format into a third data format associated with a matching rule defining a matching process (S12).

Then, the second information processing apparatus 1 applies the matching process to the target data to which the second conversion process has been applied (S13). In accordance with a result of the matching process, the second information processing apparatus 1 provides the target data to the third information processing apparatus 102 (S14).

Lastly, the third information processing apparatus 102 obtains the data provided by the second information processing apparatus 1, and executes a process on the data thus obtained (S112).

As described above, the matching process is applied to the target data to which the second conversion process has been applied. Consequently, along with changing the format into the standard format or common format, it is possible to carry out the matching process, without changing the matching rule having been created.

### Third Example Embodiment

The following description will discuss a third example embodiment of the present invention in detail with reference to the drawings. Note that members having identical functions to those of the first and second example embodiments are predetermined identical reference signs, and a description thereof will be omitted.

### <Configuration of Information Processing System 100A>

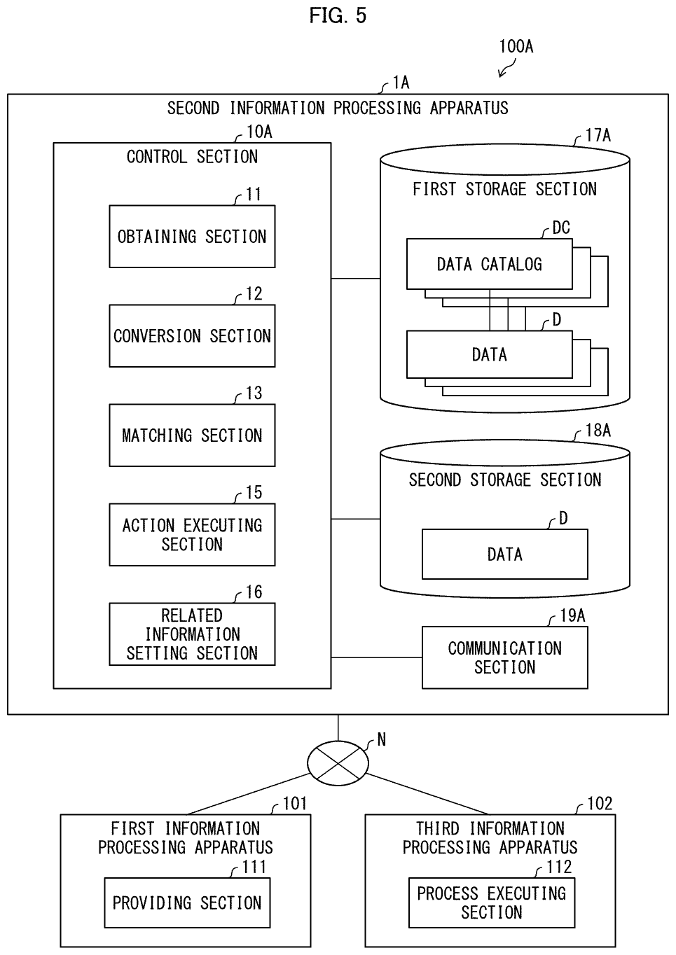

FIG. 5 is a block diagram illustrating a configuration of an information processing apparatus in accordance with a third example embodiment of the present invention. An information processing system 100A includes a first information processing apparatus 101, a third information processing apparatus 102, and a second information processing apparatus 1A. The second information processing apparatus 1A includes a control section 11, a first storage section 17A that stores therein target data to which a first conversion process has not been applied yet, a second storage section 18A that stores therein the target data to which the first conversion process has been applied, and a communication section 19A. The first storage section 17A is a configuration realizing a first storage means in the present example embodiment. The second storage section 18A is a configuration realizing a second storage means in the present example embodiment. Here, similarly to the first and second example embodiments, the second information processing apparatus 1A can also be called a “data distribution apparatus”.

Further, the control section 10A includes: an obtaining section 11 that obtains target data; a conversion section 12 that applies, to the target data, a first conversion process of converting a first data format into a predetermined second data format and a second conversion process of converting the predetermined second data format into a third data format associated with a matching rule defining a matching process; a matching section 13 that applies the matching process to the target data to which the second conversion process has been applied; an action executing section 15 that executes an action with respect to the target data in accordance with a result of the matching process carried out by the matching section 13; and a related information setting section 16 that sets related information with reference to an input from a user. The action executing section 15 is a configuration realizing an action executing means in the present example embodiment. The related information setting section 16 has a configuration that realizes a related information setting section means in the present example embodiment.

Further, the conversion section 12 may be configured to refer to related information involved in the target data and determine whether to apply the first conversion process to the target data. As described above, the data catalog stores therein data for retrieving necessary data, such as metadata indicating descriptive information of the data, an explanation text, and/or sample data. These pieces of data can serve as the related information.

Further, the conversion section 12 may be configured to select, in accordance with a source from which the target data is read, whether the second conversion process is to be applied to the target data or both the first conversion process and the second conversion process are to be applied to the target data.

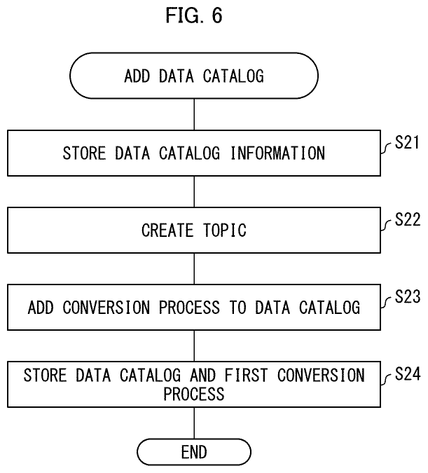

FIG. 6 is a flowchart illustrating a process of adding a data catalog. Assume that a data owner carries out a process of adding a data catalog with use of the first information processing apparatus 101 shown in FIGS. 3 and 5. With reference to FIG. 5 illustrating a configuration of the information processing system 100A, the following description will discuss the process of adding the data catalog.

First, with use of the first information processing apparatus 101, the data owner creates data catalog information and stores the data catalog information thus created (S21). Then, the data owner creates a topic corresponding to the data catalog thus created (S22). The data catalog information is a concept including the data catalog and data involved in the data catalog. As described above, the topic is a transmission destination in which the data provided by the data owner is registered. The data provided by the data owner is distributed to a data user having registered for this topic.

Subsequently, in adding a first conversion process to the data catalog, the data owner creates a first conversion process and adds the first conversion process to the data catalog information (S23), and stores the created data catalog information and the topic in the second information processing apparatus 1A (S24). During this process, the providing section 111 transmits the created data catalog information and the topic to the second information processing apparatus 1A via a network N. The second information processing apparatus 1A receives the data catalog information and the topic from the first information processing apparatus 101 via the communication section 19A, and stores the data catalog information and the topic in the first storage section 17A.

As shown in FIG. 5, in the first storage section 17A, data catalogs DC and pieces of data corresponding to the data catalogs DC are stored so as to be uniquely associated with each other.

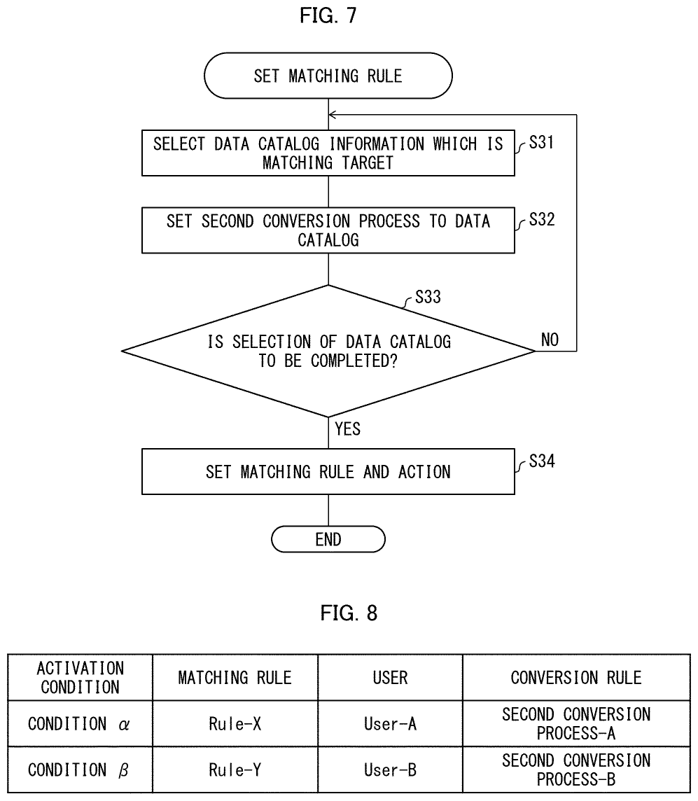

FIG. 7 is a flowchart illustrating a process of setting a matching rule. Assume that a data user carries out the process of setting the matching rule with use of the third information processing apparatus 102 shown in FIGS. 3 and 5. With reference to FIG. 5 illustrating a configuration of the information processing system 100A, the following description will discuss the process of setting the matching rule.

First, with use of the third information processing apparatus 102, the data user selects data catalog information which is a target of matching, from among the data catalogs registered in the second information processing apparatus 1A (S31). For example, the third information processing apparatus 102 receives a list of the data catalogs registered in the first storage section 17A of the second information processing apparatus 1A, and displays the list on a screen. Then, with reference to the list of the data catalogs, the data user selects the data catalog which is the target of matching.

Subsequently, the data user sets a second conversion process to the data catalog thus selected (S32). For example, the data user sets the second conversion process with reference to a first conversion process registered in the data catalog and/or sample data having been subjected to the first conversion process. The second conversion process is associated with a matching rule defining a matching process.

Next, it is determined whether or not selection of the data catalog is completed (S33). If there is an additional data catalog for setting the second conversion process (S33, No), the process returns to step S31 and the processes of step S31 and its subsequent steps are carried out again.

Further, if there is no additional data catalog for setting the second conversion process (S33, Yes), the data user sets the matching rule and an action (S34). The action defines a content of a process to be executed when an event occurred matches the matching rule. Specific examples of the matching rule and the action will be described later.

The process executing section 112 transmits, to the second information processing apparatus 1A via the network N, the second conversion process, the matching rule, and the action having been set. The second information processing apparatus 1A receives the second conversion process, the matching rule, and the action from the third information processing apparatus 102 via the communication section 19A, and registers the second conversion process, the matching rule, and the action in the first storage section 17A.

FIG. 8 is a view illustrating an example of an image of setting information. The second conversion process, the matching rule, and the action set by the data user are registered in the first storage section 17A of the second information processing apparatus 1A. As shown in FIG. 8, the setting information includes an activation condition, a matching rule, a user, and a conversion rule. The activation condition defines a condition of a case where the matching process is to be carried out. If the activation condition is satisfied, the matching process is carried out.

The example shown in FIG. 8 indicates that (i) a matching rule “Rule-X” set by a user “User-A” is applied when an activation condition “a” is satisfied and (ii) applied as a second conversion process in this case is “second conversion process-A”.

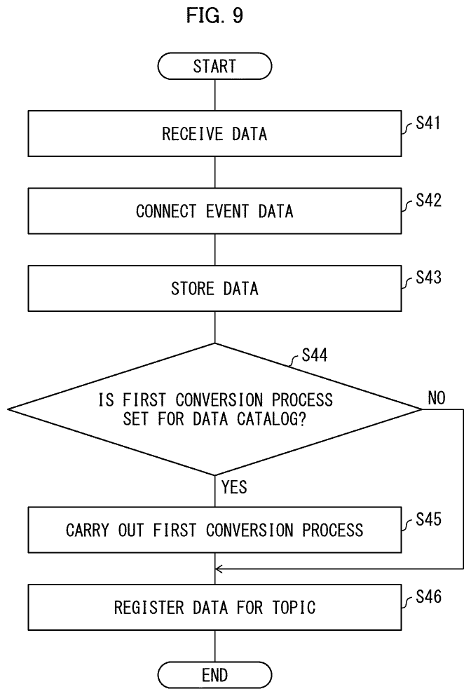

FIG. 9 is a flowchart illustrating a data receiving process at the time of data distribution. This process is a process to be carried out by the second information processing apparatus 1A when data is distributed. Upon reception of data via the network N (S41), the second information processing apparatus 1A carries out connection with event data (S42), and stores the received data in the first storage section 17A as original data (S43). A region of the first storage section 17A in which region the original data is stored in this process will be called a “data store”. In this process, the received data is analyzed, and connection with the event data is carried out. For example, it is determined which of the matching rules in the setting information shown in FIG. 8 is to be applied to the received data, and the received data is associated with a matching rule thus selected.

Subsequently, the obtaining section 11 reads, from the first storage section 17A, a data catalog associated with the received data, and determines whether or not a first conversion process is set for the data catalog (S44). If no first conversion process is set for the data catalog (S44, No), the process advances to step S46. Meanwhile, if a first conversion process is set for the data catalog (S44, Yes), the conversion section 12 carries out the first conversion process on the data (S45).

In step S46, the data is registered for a topic. If no first conversion process is set for the data catalog, the received data is registered as it is. Meanwhile, if a first conversion process is set for the data catalog, data having been subjected to the first conversion process is registered.

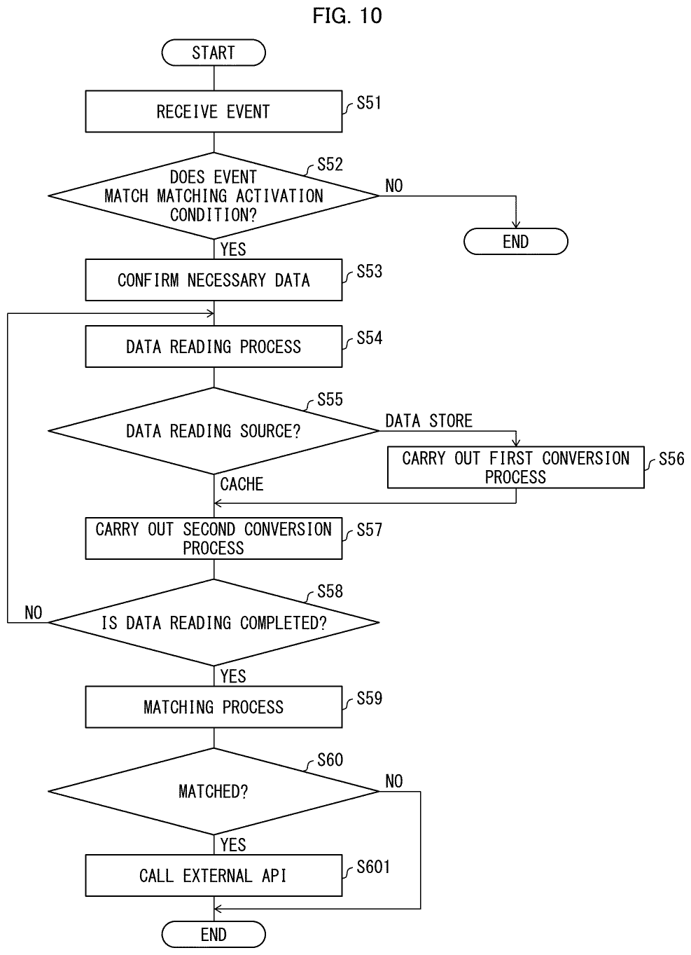

FIG. 10 is a flowchart illustrating a matching process carried out when an event occurs. Here, examples of the event can include a case where the second information processing apparatus 1A receives sales information of a predetermined company and a case where the second information processing apparatus 1A receives information indicating that a specific person enters a certain shop, as described later.

Next, the matching section 13 obtains, from the first storage section 17A, an activation condition of a matching rule corresponding to the received event, and determines whether or not the event matches the matching activation condition (S52). If the event does not matches the matching activation condition (S52, No), the process is ended.

Meanwhile, if the event matches the matching activation condition (S52, Yes), the matching section 13 confirms data necessary to carry out the matching process (S53), and reads, from the first storage section 17A, the data necessary to carry out the matching process (S54).

Next, the matching section 13 determines whether a read source of the data to be read is a data store or a cache (S55). The second storage section 18A can serve as a cache. If the first conversion process has been carried out on data stored in the data store (first storage section 17A), the data having been subjected to the first conversion process is stored in the second storage section 18A as data D. Thus, if the first conversion process has been carried out on the data, data is read from the second storage section 18A. Meanwhile, if the second conversion process has not been carried out on the data, data is read from the data store.

If the read source of the data is the data store (S55, data store), the matching section 13 carries out the first conversion process on the data having been read (S56). Then, the process advances to step S57. Meanwhile, if the read source of the data is the cache (S55, cache), the process advances to step S57 as it is.

In step S57, the conversion section 12 carries out the second conversion process on the data having been read. Then, the matching section 13 determines whether or not all the pieces of data necessary for the matching process have been read out (S58). If read-out of the data is not completed (S58, No), the process returns to step S54 and the process of step S54 and its subsequent steps are carried out again.

Meanwhile, if read-out of data is completed (S58, Yes), the matching process is carried out (S59). The matching process is a process of carrying out an arithmetic process on the data having been read and determining whether or not the data matches the matching rule. A specific example of the matching process will be described later.

If the data does not match the matching rule (S60, No), the process is ended. If the data matches the matching rule (S60, Yes), the action executing section 15 calls an external Application Programming Interface (API) corresponding to the matching rule (action operation) (S601), and the process is ended. A specific example of the action operation will be described later.

As described above, the matching section 13 applies the matching process to target data to which the second conversion process has been applied, and the action executing section 15 executes an action with respect to the target data in accordance with a result of the matching process carried out by the matching section 13. Consequently, along with changing the format into a standard format or a common format, it is possible to carry out the matching process, without changing the matching rule having been created. Further, it is possible to execute the action corresponding to the result of the matching process.

### Specific Example 1 of Operation

The following will describe a specific example 1 of operation of the second information processing apparatus 1A.

### <Assumed Scene>

Assume the following case: a plurality of users subscribe a data distribution platform; and the users exchange data and utilize the data via their own systems, and the users can utilize the exchanged data also via a common system. Companies A and B which deal with common POS sales data use the same data distribution platform; however, companies A and B use respective different POS systems and respective different formats of product master DBs.

In order to unify/improve efficiency of inventory management, companies A and B form a business partnership and use a common inventory management system. Thus, in order that data on the data distribution platform can be commonly used via a company A's inventory management system regardless of whether the data is POS sales data of company A or POS sales data of company B, a first conversion process is carried out so that a format of the data is converted into a format suitable for the inventory management system. Further, assuming that company A processes POS sales data of company B through company A's analysis system and company B processes POS sales data of company A through company B's analysis system, a user carries out a second conversion process so as to convert, as necessary, a format into a format conforming to the specification of the analysis system of each company.

### <Explanation of Event, Matching Rule, and the Like>

Data distribution platform: Pieces of POS sales data of companies A and B are distributed.
Event: Occurrence of POS sales data.
Common system: For example, the company A's inventory management system which is connected to the data distribution platform via an external API.
Matching activation condition: The pieces of POS sales data are pieces of sales data of a product code A1 (B1) and a product name A2 (B2).
Matching rule: An amount of stock of a product is lower than a lower limit, according to the pieces of data obtained through the data distribution platform.
First conversion process: Deleting, from an original data format, information (such as a point card number) unnecessary for the matching process (converting the product code and product name used in company B into the product code and product name used in company A).
Second conversion process: Converting the product code and product name used in company A into the product code and product name used in company B.
Own system: For example, company A's analysis system and company B's analysis system, each of which analyzes both of the data of company A and the data of company B.

### <Flow of Process>

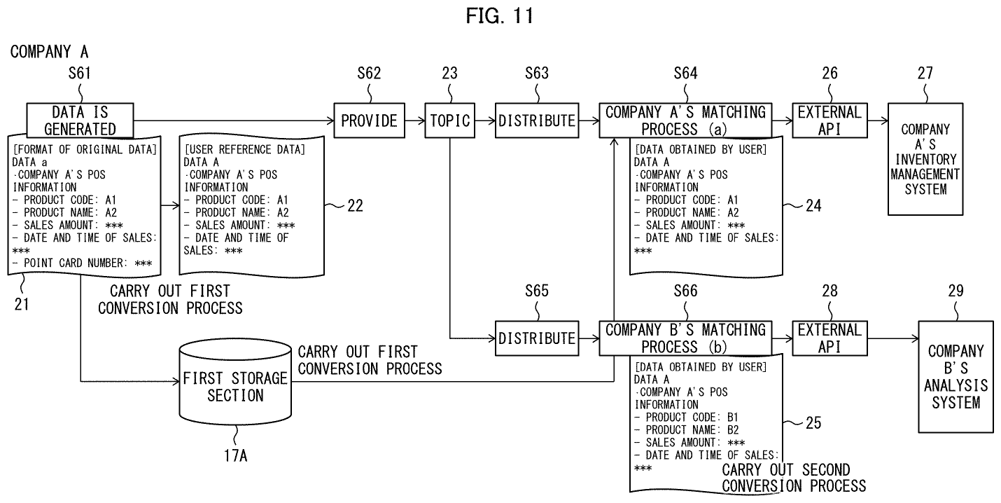

FIG. 11 is a view illustrating the specific example 1 of operation of the second information processing apparatus 1A. FIG. 11 illustrates a case where company A's POS sales data is provided. First, company A's POS sales data is generated (S61). As shown in FIG. 11, original data 21 is company A's POS information in a data format a, including a product code of A1 and a product name of A2, an amount of sales, date and time of sales, and a point card number. The conversion section 12 carries out the first conversion process on the original data 21, so as to create user reference data 22. The user reference data 22 is converted into a data format A, so that the point card number is deleted.

In the description below, a matching process registered by company A with respect to the second information processing apparatus 1A may also be called a “company A's matching process”, and a matching process registered by company B with respect to the second information processing apparatus 1A may also be called a “company B's matching process”.

The user reference data 22 thus created is provided (S62). The user reference data 22 is registered for a topic 23 corresponding thereto. The user reference data 22 registered for the topic 23 is distributed (S63), and the matching section 13 carries out a company A's matching process (a). The matching section 13 obtains, from among data stored in the first storage section 17A and 18A, data (sales data of a product code A1 and a product name A2) relating to the company A's matching process. For example, the matching 13 obtains data 24 obtained by a user, and calculates a total value of amounts of sales. Then, the matching section 13 calculates an amount of stock on the basis of the total value of the amounts of sales. If the amount of stock is lower than the lower limit, the matching section 13 determines that the data matches the matching rule, and carries out an action operation of calling an external API 26 (S64). As a result of the action operation, a company A's inventory management system 27 is activated.

Further, the user reference data 22 registered for the topic 23 is distributed (S65), and the matching section 13 carries out a company B's matching process (b). The matching section 13 obtains, from among data stored in the first storage section 17A and 18A, data (sales data of product code A1 and product name A2) relating to the company A's matching process. Then, the conversion section 12 carries out the first conversion process on the data thus obtained. Further, since the second conversion process is associated with a matching rule of the company B's matching process (b), the conversion section 12 carries out the second conversion process on the data on which the first conversion process has been carried out. As a result of the second conversion process, data 25 is created whose product code has been converted into B1, whose product name has been converted into B2, and which is to be obtained by the user.

In the company B's matching process (b), the matching process created and registered by company B is applied. Assume that this matching rule defines a rule for analyzing sales of a product via a company B's analysis system. If the data matches the matching rule, the matching section 13 carries out an action operation of calling an external API 28 (S66). As a result of this action operation, the company B's analysis system 29 is activated.

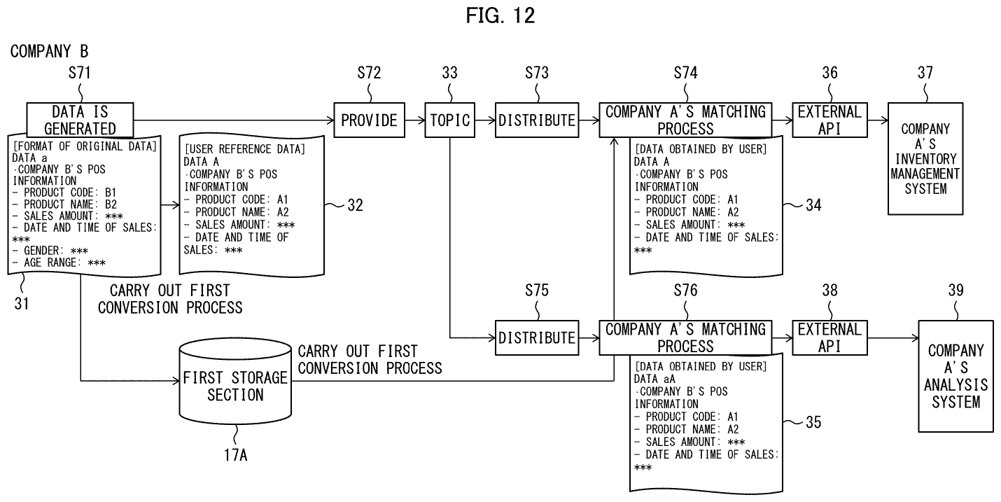

FIG. 12 is a view illustrating another specific example 1 of operation of the second information processing apparatus 1A. FIG. 12 illustrates a case where company B's POS sales data is provided. First, company B's POS sales data is generated (S71). As shown in FIG. 12, original data 31 is company B's POS information in a data format a, including a product code B, a product name B2, an amount of sales, date and time of sales, gender, and an age range. The conversion section 12 carries out the first conversion process on the original data 31, so as to create user reference data 32. The user reference data 32 is converted into a data format A in which the gender and the age range are deleted, the product code B1 has been converted into A1, and the product name B2 has been converted into A2.

The user reference data 32 thus created is provided (S72). The user reference data 32 is registered for a topic 33 corresponding thereto. The user reference data 32 registered for the topic 33 is distributed (S73), and the matching section 13 carries out a company A's matching process. The matching section 13 obtains, from among data stored in the first storage section 17A and 18A, data (sales data of a product code B1 and a product name B2) relating to the company A's matching process. During this process, the first conversion process is carried out, the product codes B1 is converted into A1, and the product name B2 is converted into A2. For example, the matching section 13 obtains data 34 obtained by a user, and calculates a total value of amounts of sales. Then, the matching section 13 calculates an amount of stock on the basis of the total value of the amounts of sales. If the amount of stock is lower than the lower limit, the matching section 13 determines that the data matches the matching rule, and carries out an action operation of calling an external API 36 (S74). As a result of the action operation, a company A's inventory management system 37 is activated.

The user reference data 32 registered for the topic 33 is distributed (S75), and the matching section 13 carries out the company A's matching process. Assume that this matching rule defines a rule for analyzing sales of a product via a company A's analysis system 39. If the data matches the matching rule, the matching section 13 carries out an action operation of calling an external API 38 (S76). As a result of the action operation, a company A's analysis system 39 is activated. Note that, in this specific example, a second conversion process is not carried out, as indicated in the data 34 and the data 35 obtained by the user.

### Specific Example 2 of Operation

The following will describe a specific example 2 of operation of the second information processing apparatus 1A.

### <Assumed Scene>

Assume a case where, via a data format used by company A which is a data owner, connection with a company B's system is made, and company B's DB is referred to. Company A's DB and company B's DB are integrated together through a situation such as corporate integration, and a coupon is issued for a customer of at least 65 years old.

### <Explanation of Event, Matching Rule, and the Like>

Company A's DB: Possesses customer data in the form of age information (Japanese calendar).
Company B's DB: Possesses customer data in the form of age information (Western calendar).
Event: Person's entering a specific position.
Matching activation condition: Person's entering a shop is detected through a user's position information detection service.
Matching rule: The person who entered the shop is determined to be not less than 65 years old, on the basis of customer list information in the company B's DB.
External API: Coupon issue system.
First conversion process: A birthdate in an original data format is converted from the one in Japanese calendar into the one in Western calendar.
Second conversion process: A birthdate is converted from the one in Western calendar into the one in a numerical format.

### <Flow of Process>

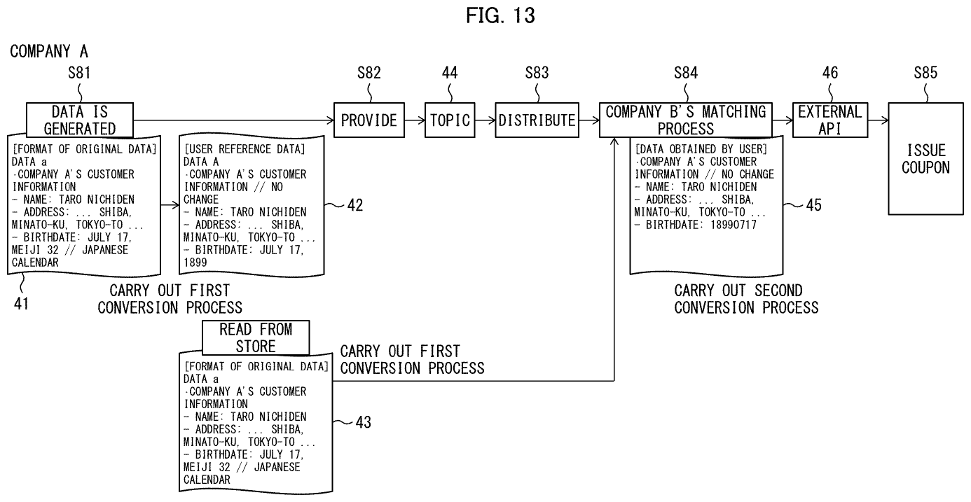

FIG. 13 is a view illustrating the specific example 2 of operation of the second information processing apparatus 1A. First, when a customer enters a shop, data is generated (S81). As shown in FIG. 13, original data 41 is company A's customer information in a data format a, including a name, an address, and a birthdate (Japanese calendar). The conversion section 12 carries out the first conversion process on the original data 41, so as to create user reference data 42. The user reference data 42 has been converted into a data format A, so that the birthdate in Japanese calendar is converted into the birthdate in Western calendar.

The user reference data 42 thus created is provided (S82). The user reference data 42 is registered for a topic 44 corresponding thereto. The user reference data 42 registered for the topic 44 is distributed (S83), and the matching section 13 carries out a company B's matching process. The matching section 13 obtains, from among data stored in the first storage section 17A and 18A, data (company A's customer information) relating to the company B's matching process.

For example, the conversion section 12 obtains the original data 43, and carries out the first conversion process so that a customer's birthdate in Japanese calendar is converted into the one in Western calendar. Then, the conversion section 13 further carries out the second conversion process so that the customer's birthdate in Western calendar into the one in a numerical format. The matching section 13 calculates an age on the basis of the birthdate in the numerical format. If the customer's age is not less than 65 years old, the matching section 13 determines that the data matches the matching rule, and carries out an action operation of calling an external API 46 (S84). As a result of the action operation, a coupon is issued (S85).

### Specific Example 3 of Operation

The following will describe a specific example 3 of operation of the second information processing apparatus 1A.

### <Assumed Scene>

Assume a case where a data owner is also an owner of a distribution platform and data is distributed in a data distribution platform without being subjected to conversion.

### <Explanation of Event, Matching Rule, and the Like>

Event: Occurrence of heat amount data.
Matching activation condition: Relating to a heat amount.
Matching rule: A total heat amount exceeds a predetermined value.
First conversion process: Not necessary.
Second conversion process: A unit of data indicating the heat amount is converted from calorie (cal) to Joule (heat amount (J)=heat amount (cal)×4.184).

### <Flow of Process>

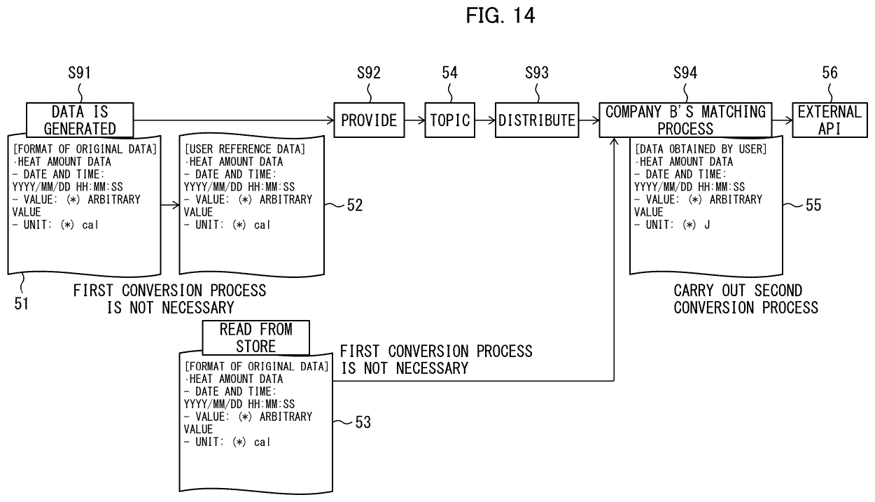

FIG. 14 is a view illustrating the specific example 3 of operation of the second information processing apparatus 1A. First, data relating to a heat amount is generated (S91). As shown in FIG. 14, original data 51 is heat amount data, and includes date and time and a value (cal). The conversion section 12 does not carry out the first conversion process on the original data 51, but uses the original data 51 as user reference data 52.

The user reference data 52 thus created is provided (S92). The user reference data 52 is registered for a topic 54 corresponding thereto. The user reference data 52 registered for the topic 54 is distributed (S93), and the matching section 13 carries out a company B's matching process. The matching section 13 obtains, from among data stored in the first storage section 17A and 18A, data (data relating to a heat amount) relating to the company B's matching process.

For example, the conversion section 12 obtains the original data 53, and carries out the second conversion process so that a heat amount in calorie into the one in Joule. The matching section 13 calculates a total heat amount. If the total heat amount exceeds a predetermined value, the matching section 13 determines that the data matches the matching rule, and carries out an action operation of calling an external API 56 (S94). As a result of the action operation, a predetermined operation is carried out.

### [Software Implementation Example]

Part of or the whole of functions of the information processing apparatuses 1 and 1A can be realized by hardware such as an integrated circuit (IC chip) or can be alternatively realized by software.

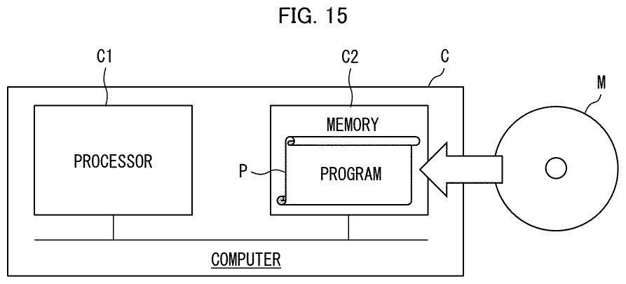

In the latter case, each of the information processing apparatuses 1 and 1A is realized by, for example, a computer that executes instructions of a program that is software realizing the foregoing functions. FIG. 15 shows an example of such a computer (hereinafter, referred to as a “computer C”). The computer C includes at least one processor C1 and at least one memory C2. The memory C2 has a program P stored therein, the program P causing the computer C to operate as the information processing apparatus 1 or 1A. In the computer C, the processor C1 reads and executes the program P from the memory C2, thereby realizing the functions of the information processing apparatus 1 or 1A.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination of any of them. The memory C2 may be, for example, a flash memory, hard disk drive (HDD), solid state drive (SSD), or a combination of any of them.

The computer C may further include a random access memory (RAM) in which the program P is loaded when executed and various data is temporarily stored. In addition, the computer C may further include a communication interface via which the computer C transmits/receives data to/from another device. The computer C may further include an input-output interface via which the computer C is connected to an input-output device such as a keyboard, a mouse, a display, and/or a printer.

The program P can be stored in a non-transitory, tangible storage medium M capable of being read by a computer C. Examples of the storage medium M encompass a tape, a disk, a card, a semiconductor memory, and a programmable logic circuit. The computer C can obtain the program P via the storage medium M. Alternatively, the program P can be transmitted via a transmission medium. Examples of such a transmission medium encompass a communication network and a broadcast wave. The computer C can also obtain the program P via the transmission medium.

### [Supplementary Remarks 1]

The present invention is not limited to the foregoing example embodiments, but can be altered by a skilled person in the art within the scope of the claims. The present invention also encompasses, in its technical scope, any embodiment derived by combining technical means disclosed in differing embodiments.

### [Supplementary Remarks 2]

Some or all of the foregoing example embodiments can be described as below. Note, however, that the present invention is not limited to aspects described below.

### (Supplementary Note 1)

An information processing apparatus including: an obtaining means that obtains target data; and a conversion means that (a) selects at least either of a first conversion process of converting a first data format into a predetermined second data format and a second conversion process of converting the predetermined second data format into a third data format associated with a matching rule defining a matching process and (b) applies, to the target data, the at least either of the first conversion process and the second conversion process thus selected.

With the above configuration, along with changing the format into the predetermined format, it is possible to obtain data conforming to the predetermined format, without rewriting the accumulated data. Further, along with changing the format into the predetermined format, it is possible to use the matching rule as it is, without changing the matching rule having been created.

### (Supplementary Note 2)

The information processing apparatus described in Supplementary Note 1, wherein: the conversion means executes at least the second conversion process; and the information processing apparatus further includes: a matching means that applies the matching process to the target data to which the second conversion process has been applied.

With the above configuration, along with changing the format into the predetermined format, it is possible to carry out the matching process, without changing the matching rule having been created.

### (Supplementary Note 3)

The information processing apparatus described in Supplementary Note 2, wherein: the conversion means executes the second conversion process so as to (a) select any one of a plurality of matching processes and (b) convert the predetermined second data format into a third data format associated with a matching rule defining the one of the plurality of matching processes thus selected; and the matching means applies, to the target data to which the second conversion process has been applied, the one of the plurality of matching processes selected by the conversion means.

With the above configuration, it is possible to select an appropriate matching process from among the plurality of matching processes.

### (Supplementary Note 4)

The information processing apparatus described in Supplementary Note 2 or 3, further including: an action executing means that executes an action with respect to the target data in accordance with a result of the matching process carried out by the matching means.

With the above configuration, it is possible to execute an action according to the result of the matching process.

### (Supplementary Note 5)

The information processing apparatus described in any one of Supplementary Notes 1 to 4, wherein: the conversion means refers to related information involved in the target data and determines whether to apply the first conversion process to the target data.

With the above configuration, it is possible to apply a suitable first conversion process to the target data.

### (Supplementary Note 6)

The information processing apparatus described in Supplementary Note 5, further including: a related information setting means that sets the related information with reference to an input from a user.

### (Supplementary Note 7)

The information processing apparatus described in any one of Supplementary Notes 1 to 6, wherein: the conversion means selects, in accordance a source from which the target data is read, whether the second conversion process is to be applied to the target data or both the first conversion process and the second conversion process are to be applied to the target data.

With the above configuration, it is possible to apply a suitable conversion process in accordance the source from which the target data is read.

### (Supplementary Note 8)

The information processing apparatus described in Supplementary Note 7, further including: a first storage means that stores therein the target data to which the first conversion process has not been applied yet; and a second storage means that stores therein the target data to which the first conversion process has been applied.

With the above configuration, if the target data is read from the second storage means, it is not necessary to carry out the first conversion process.

### (Supplementary Note 9)

An information processing apparatus including: an obtaining means that obtains target data having a predetermined first data format; and a conversion means that executes a conversion process of converting the data format of the target data into a second data format associated with a matching rule defining a matching process.

With the above configuration, along with changing the format into the predetermined format, it is possible to use the matching rule as it is, without changing the matching rule having been created.

### (Supplementary Note 10)

The information processing apparatus described in Supplementary Note 9, further including: a matching means that applies the matching process to the target data to which the conversion process has been applied.

With the above configuration, along with changing the format into the predetermined format, it is possible to carry out the matching process, without changing the matching rule having been created.

### (Supplementary Note 11)

The information processing apparatus described in Supplementary Note 10, wherein: the conversion means executes conversion process so as to (a) select any one of a plurality of matching processes and (b) convert the predetermined first data format into a second data format associated with a matching rule defining the one of the plurality of matching processes thus selected; and the matching means applies, to the target data to which the conversion process has been applied, the one of the plurality of matching processes selected by the conversion means.

With the above configuration, it is possible to select an appropriate matching process from among the plurality of matching processes.

### (Supplementary Note 12)

The information processing apparatus described in Supplementary Note 10 or 11, further including: an action executing means that executes an action with respect to the target data in accordance with a result of the matching process carried out by the matching means.

With the above configuration, it is possible to execute an action in accordance with the result of the matching process.

### (Supplementary Note 13)

An information processing system including: a first information processing apparatus; a second information processing apparatus; and a third information processing apparatus, the first information processing apparatus including: a providing means that provides target data to the second information processing apparatus, the second information processing apparatus including: an obtaining means that obtains the target data; a conversion means that applies, to the target data, a first conversion process of converting a first data format into a predetermined second data format and a second conversion process of converting the predetermined second data format into a third data format associated with a matching rule defining a matching process; a matching means that applies the matching process to the target data to which the second conversion process has been applied; and a data providing means that provides at least part of the target data to the third information processing apparatus in accordance with a result of the matching process carried out by the matching means, the third information processing apparatus including: a process executing means that obtains the data provided by the second information processing apparatus and executes a process on the data thus obtained.

With the above configuration, along with changing the format into the predetermined format, it is possible to obtain data conforming to the predetermined format, without rewriting the accumulated data. Further, along with changing the format into the predetermined format, it is possible to use the matching rule as it is, without changing the matching rule having been created.

### (Supplementary Note 14)

An information processing system including: a first information processing apparatus; a second information processing apparatus; and a third information processing apparatus, the first information processing apparatus including: a providing means that provides target data to the second information processing apparatus, the second information processing apparatus including: an obtaining means that obtains target data having a predetermined first data format; a conversion means that executes a conversion process of converting the data format of the target data into a second data format associated with a matching rule defining a matching process; a matching means that applies the matching process to the target data to which the conversion process has been applied; and a data providing means that provides at least part of the target data to the third information processing apparatus in accordance with a result of the matching process carried out by the matching means, the third information processing apparatus including: a process executing means that obtains the data provided by the second information processing apparatus and executes a process on the data thus obtained.

With the above configuration, along with changing the format into the predetermined format, it is possible to use the matching rule as it is, without changing the matching rule having been created.

### (Supplementary Note 15)

An information processing method including an information processing apparatus carrying out: obtaining target data; and selecting at least either of a first conversion process of converting a first data format into a predetermined second data format and a second conversion process of converting the predetermined second data format into a third data format associated with a matching rule defining a matching process and applying, to the target data, the at least either of the first conversion process and the second conversion process thus selected.

With the above configuration, along with changing the format into the predetermined format, it is possible to obtain data conforming to the predetermined format, without rewriting the accumulated data. Further, along with changing the format into the predetermined format, it is possible to use the matching rule as it is, without changing the matching rule having been created.

### (Supplementary Note 16)

An information processing method including an information processing apparatus carrying out: obtaining target data having a predetermined first data format; and converting the data format of the target data into a second data format associated with a matching rule defining a matching process.

With the above configuration, along with changing the format into the predetermined format, it is possible to use the matching rule as it is, without changing the matching rule having been created.

### (Supplementary Note 17)

An information processing method including: a first information processing apparatus carrying out: providing target data to a second information processing apparatus; a second information processing apparatus carrying out: obtaining the target data; applying, to the target data, a first conversion process of converting a first data format into a predetermined second data format and a second conversion process of converting the predetermined second data format into a third data format associated with a matching rule defining a matching process; applying the matching process to the target data to which the second conversion process has been applied; and providing the target data to a third information processing apparatus in accordance with a result of the matching process; and the third information processing apparatus carrying out: obtaining the data provided by the second information processing apparatus and executing a process on the data thus obtained.

With the above configuration, along with changing the format into the predetermined format, it is possible to obtain data conforming to the predetermined format, without rewriting the accumulated data. Further, along with changing the format into the predetermined format, it is possible to use the matching rule as it is, without changing the matching rule having been created.

### (Supplementary Note 18)

An information processing method including: a first information processing apparatus carrying out: providing target data to a second information processing apparatus; a second information processing apparatus carrying out: obtaining target data having a predetermined first data format; and executing a conversion process of converting the data format of the target data into a second data format associated with a matching rule defining a matching process; applying the matching process to the target data to which the conversion process has been applied; and providing the target data to a third information processing apparatus in accordance with a result of the matching process; and a third information processing apparatus carrying out: obtaining the data provided by the second information processing apparatus and executing a process on the data thus obtained.

With the above configuration, along with changing the format into the predetermined format, it is possible to use the matching rule as it is, without changing the matching rule having been created.

### (Supplementary Note 19)

A program for causing a computer to function as an information processing apparatus, the program causing the computer to function as: an obtaining means that obtains target data; and a conversion means that (a) selects at least either of a first conversion process of converting a first data format into a predetermined second data format and a second conversion process of converting the predetermined second data format into a third data format associated with a matching rule defining a matching process and (b) applies, to the target data, the at least either of the first conversion process and the second conversion process thus selected.

With the above configuration, along with changing the format into the predetermined format, it is possible to obtain data conforming to the predetermined format, without rewriting the accumulated data. Further, along with changing the format into the predetermined format, it is possible to use the matching rule as it is, without changing the matching rule having been created.

### (Supplementary Note 20)

A program for causing a computer to function as an information processing apparatus, the program causing the computer to function as: an obtaining means that obtains target data having a predetermined first data format; and a conversion means that converts the data format of the target data into a second data format associated with a matching rule defining a matching process.

With the above configuration, along with changing the format into the predetermined format, it is possible to use the matching rule as it is, without changing the matching rule having been created.

### (Supplementary Note 21)

An information processing apparatus including at least one processor, the at least one processor executing: a process of obtaining target data; and a process of (a) selecting at least either of a first conversion process of converting a first data format into a predetermined second data format and a second conversion process of converting the predetermined second data format into a third data format associated with a matching rule defining a matching process and (b) applying, to the target data, the at least either of the first conversion process and the second conversion process thus selected.

Note that the information processing apparatus may further include a memory. In the memory, a program causing the processor to execute the process of obtaining and the process of applying may be stored. The program may be stored in a non-transitory, tangible storage medium capable of being read by a computer.

### (Supplementary Note 22)

An information processing apparatus including at least one processor, the at least one processor executing: a process of obtaining target data having a predetermined first data format; and a process of executing a conversion process of converting the data format of the target data into a second data format associated with a matching rule defining a matching process.

Note that the information processing apparatus may further include a memory. In the memory, a program causing the processor to execute the process of obtaining and the process of executing may be stored. The program may be stored in a non-transitory, tangible storage medium capable of being read by a computer.

### REFERENCE SIGNS LIST

1: information processing apparatus
1A: second information processing apparatus (information processing apparatus)
10A: control section
11: obtaining section
12: conversion section
13: matching section
14: data providing section
15: action executing section
16: related information setting section
17A: first storage section
18A: second storage section
19A: communication section
100, 100A: information processing system
101: first information processing apparatus
102: third information processing apparatus
111: providing section
112: process executing section

What is claimed is:

1. An information processing apparatus comprising at least one processor, the at least one processor executing:
a process of obtaining target data; and
a process of (a) selecting at least either of a first conversion process of converting a first data format into a predetermined second data format and a second conversion process of converting the predetermined second data format into a third data format associated with a matching rule defining a matching process and (b) applying, to the target data, the at least either of the first conversion process and the second conversion process thus selected.

2. The information processing apparatus according to claim 1, wherein:
in the process of selecting and applying, the at least one processor executes at least the second conversion process; and
the at least one processor applies the matching process to the target data to which the second conversion process has been applied.

3. The information processing apparatus according to claim 2, wherein:
in the process of selecting and applying, the at least one processor executes the second conversion process so as to (a) select any one of a plurality of matching processes and (b) convert the predetermined second data format into a third data format associated with a matching rule defining the one of the plurality of matching processes thus selected; and
the at least one processor applies, to the target data to which the second conversion process has been applied, the one of the plurality of matching processes thus selected.

4. The information processing apparatus according to claim 2, wherein:
the at least one processor executes an action with respect to the target data in accordance with a result of the matching process.

5. The information processing apparatus according to claim 1, wherein:
the process of selecting and applying, the at least one processor refers to related information involved in the target data and determines whether to apply the first conversion process to the target data.

6. The information processing apparatus according to claim 5, wherein:
the at least one processor executes a process of setting the related information with reference to an input from a user.

7. The information processing apparatus according to claim 1, wherein:
the process of selecting and applying, the at least one processor selects, in accordance a source from which the target data is read, whether the second conversion process is to be applied to the target data or both the first conversion process and the second conversion process are to be applied to the target data.

8. The information processing apparatus according to claim 7, wherein:
the at least one processor executes:
a process of storing the target data to which the first conversion process has not been applied yet; and
a process of storing the target data to which the first conversion process has been applied.

9. An information processing apparatus comprising at least one processor, the at least one processor executing:
a process of obtaining target data having a predetermined first data format; and
a process of executing a conversion process of converting the data format of the target data into a second data format associated with a matching rule defining a matching process.

10. The information processing apparatus according to claim 9, wherein:
the at least one processor applies the matching process to the target data to which the conversion process has been applied.

11. The information processing apparatus according to claim 10, wherein:
the at least one processor executes the conversion process so as to (a) select any one of a plurality of matching processes and (b) convert the predetermined first data format into a second data format associated with a matching rule defining the one of the plurality of matching processes thus selected; and
the at least one processor applies, to the target data to which the conversion process has been applied, the one of the plurality of matching processes thus selected.

12. The information processing apparatus according to claim 10, wherein:
the at least one processor executes an action with respect to the target data in accordance with a result of the matching process.

13-14. (canceled)

15. An information processing method comprising an information processing apparatus carrying out:
obtaining target data; and
selecting at least either of a first conversion process of converting a first data format into a predetermined second data format and a second conversion process of converting the predetermined second data format into a third data format associated with a matching rule defining a matching process and applying, to the target data, the at least either of the first conversion process and the second conversion process thus selected.

16-20. (canceled)

21. The information processing method according to claim 15, wherein:
the information processing apparatus executes at least the second conversion process; and
the information processing apparatus applies the matching process to the target data to which the second conversion process has been applied.

22. The information processing method according to claim 21, wherein:
the information processing apparatus executes the second conversion process so as to (a) select any one of a plurality of matching processes and (b) convert the predetermined second data format into a third data format associated with a matching rule defining the one of the plurality of matching processes thus selected; and
the information processing apparatus applies, to the target data to which the second conversion process has been applied, the one of the plurality of matching processes thus selected.

23. The information processing method according to claim 21, wherein:
the information processing apparatus executes an action with respect to the target data in accordance with a result of the matching process.

24. The information processing method according to claim 15, wherein:
the information processing apparatus refers to related information involved in the target data and determines whether to apply the first conversion process to the target data.

25. The information processing method according to claim 24, wherein:
the information processing apparatus sets the related information with reference to an input from a user.

26. The information processing method according to claim 15, wherein:
the information processing apparatus selects, in accordance a source from which the target data is read, whether the second conversion process is to be applied to the target data or both the first conversion process and the second conversion process are to be applied to the target data.

27. The information processing method according to claim 26, wherein:
the information processing apparatus stores the target data to which the first conversion process has not been applied yet; and
the information processing apparatus stores the target data to which the first conversion process has been applied.
